(19) United States
(12) Patent Application Publication
(10) Pub. No.: US 2016/0325644 A1
(43) Pub. Date: Nov. 10, 2016

(54) ADAPTER ASSEMBLY FOR AUTOMOTIVE CHILD SEAT

(71) Applicant: Joshua Miller, Vestal, NY (US)

(72) Inventor: Joshua Miller, Vestal, NY (US)

(21) Appl. No.: 15/144,900

(22) Filed: May 3, 2016

Related U.S. Application Data
(60) Provisional application No. 62/158,565, filed on May 8, 2015.

(51) Int. Cl. B60N 2/28

(52) U.S. Cl. CPC B60N 2/2821; B60N 2/2869

(57) ABSTRACT

An adapter assembly for moving a vehicle child seat longitudinally and rotationally relative to a vehicle seat. The assembly has a bearing base plate, a rotatable turntable disposed on and connected to the bearing base plate, a top plate disposed on and connected to the rotatable turntable, and an adapter plate disposed on and connected to the top plate. The adapter plate is fabricated to couple to a child seat having predetermined dimensions.

### RELATED PATENT APPLICATION

The present application is related to U.S. Provisional Patent application No. 62/158,565 and claims the priority filing date thereof.

### FIELD OF THE INVENTION

The present invention pertains to automotive child seats and, more particularly, to an adapter assembly to aid in placing a child in a seat in a motor vehicle and removing the child therefrom.

### BACKGROUND OF THE INVENTION

Child or baby seats for use in vehicles have been shown to protect infants from injury or death in case of automotive crashes when such seats have been used properly. Unfortunately, placing a child into such a seat or removing the child therefrom is often difficult due to the immovability of the seat relative to the vehicle seat on which it rests.

It would be advantageous to provide a child or baby seat with rotational and/or linear movement capabilities, allowing a caregiver to more easily place an infant or child into such a child seat.

### DISCUSSION OF RELATED ART

U.S. Pat. No. 7,984,947 for ROTATABLE CHILD SEAT FOR MOTOR VEHICLES issued to Pos on Jul. 26, 2011 discloses a rotatable child seat for motor vehicles, having a base frame and a seat shell system. The base frame is configured to be arranged on a vehicle seat and to be held there by means of an in-vehicle safety belt system. The seat shell system has a seat shell which is rotatable relative to the base frame between a first position, in which the seat shell faces in the direction of travel, and a second position, in which the seat shell faces in the direction opposite to the direction of travel. In order effectively to prevent the seat shell system, when aligned in the second position, from breaking away from the base frame, according to the invention the child seat also has an anchoring belt which, independently of the rotated position of the seat shell system relative to the base frame, is guided by guide means over a predetermined first guide region on the rear side of the seat shell system in such a way that the anchoring belt always passes around the pivot axis and that on rotation of the seat shell system from the first position to the second position and vice versa the anchoring belt passes at least partly between the seat shell system and the base frame.

United States Published Patent Application No. 201 3/01 5431 8 for ROTATING CHILD SAFETY SEAT published on an application to Van der Veer, et al. on Jun. 20, 2013 discloses a child safety seat comprising at least a head section, a back section and a sitting section, where a base frame is connected through pivot means to the sitting section of the child safety seat, the pivot means preventing the sitting section from separating from the base frame, thereby providing a fixed connection between the sitting section and the base frame under normal utilization of the child safety seat, but allowing the head section, back section and sitting section to rotate sideways about a pivot axis in the event of a collision.

U.S. Pat. No. 4,690,449 for ROTATING CHILD'S SEAT issued to Holman on Sep. 1, 1987 discloses a rotating child's seat for mounting in the seat backrest of a vehicle, which rotating child's seat includes a rotating frame having a seat portion attached to one side thereof and a padded back portion secured to the opposite side. The rotating frame is rotatably mounted on fixed supports located in a bifurcation provided in the center section of the seat backrest. When located in functional configuration, the seat portion of the rotating child's seat faces forwardly of the backrest and extends over the rear bench seat in the vehicle to position a child securely in the back seat of the vehicle. When the rotating child's seat is not in use the rotating frame can be rotated or pivoted on pivot pins linking the rotating frame to the fixed supports, in order to position the back portion in alignment with the bifurcated backrest to accommodate one or more additional adults in the rear seat of the vehicle.

### SUMMARY OF THE INVENTION

The present invention is an adapter assembly for moving a vehicle child seat longitudinally and rotationally relative to a vehicle seat. The assembly has a bearing base plate, a rotatable turntable disposed on and connected to the bearing base plate, a top plate disposed on and connected to the rotatable turntable, and an adapter plate disposed on and connected to the top plate. The adapter plate is fabricated to couple to a child seat having predetermined dimensions.

### BRIEF DESCRIPTION OF THE DRAWING

A complete understanding of the present invention may be obtained by reference to the accompanying drawing, when considered in conjunction with the subsequent detailed description, in which:

FIG. 1 is an isometric front view of the adapter assembly of the invention;

FIG. 2 is an isometric rear view of the adapter assembly of the invention illustrating LATCH connectors secured to a LATCH connector support bracket;

FIG. 3 is an isometric front view of the invention shown in FIG. 1 without the adapter plate;

FIG. 4 is an isometric front view of the invention without the adapter plate or top plate, exposing the turntable bearing and bearing base plate;

FIG. 5 is an isometric view of the bearing base plate assembly shown in

FIG. 4;

FIG. 6 is an isometric view of the invention without the adapter plate or the bearing base plate assembly;

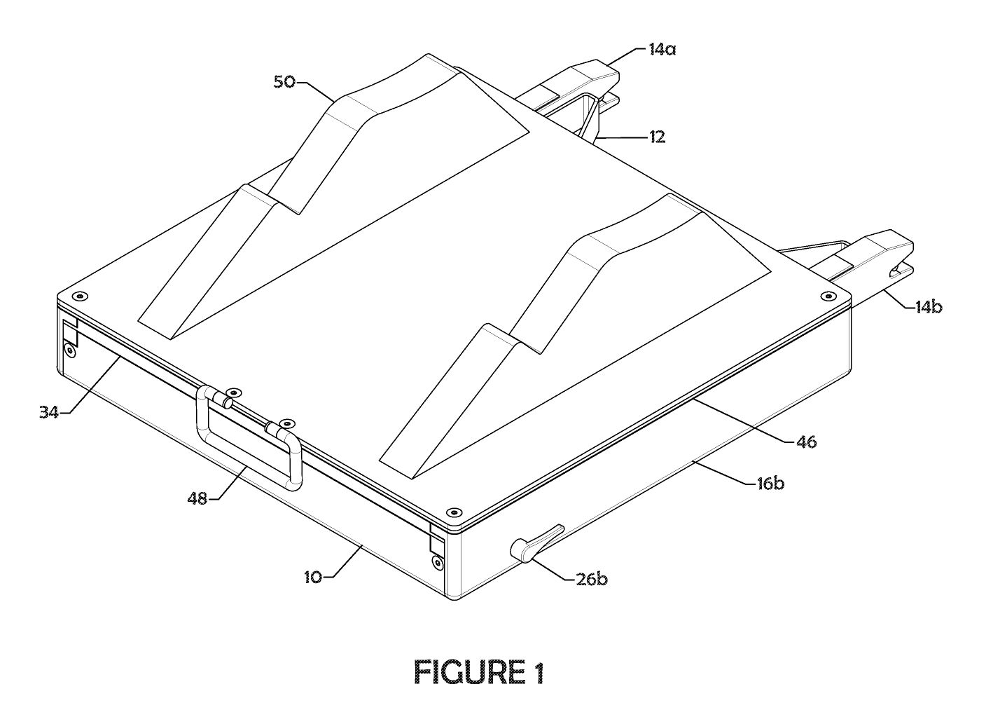

FIG. 7 is a cross sectional view of the arm shown in FIG. 1;

FIG. 8 is a right angled projection of the arm shown in FIG. 7;

FIG. 9 is a photographic view of the adapter assembly of the invention secured to a vehicle via the use of the LATCH connectors;

FIG. 10 is a photographic view of the invention moving the child seat forward; and

FIG. 11 is a photographic view of the invention rotating the child seat.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

The present invention is an adapter assembly for use with a child or baby seat that provides rotational and/or linear movement capabilities, allowing a caregiver to more easily place an infant or child into such a child seat. The adapter assembly has a number of stacked components including a bearing base plate, a rotatable turntable, a top plate, and an adapter plate disposed on and connected to the top plate.

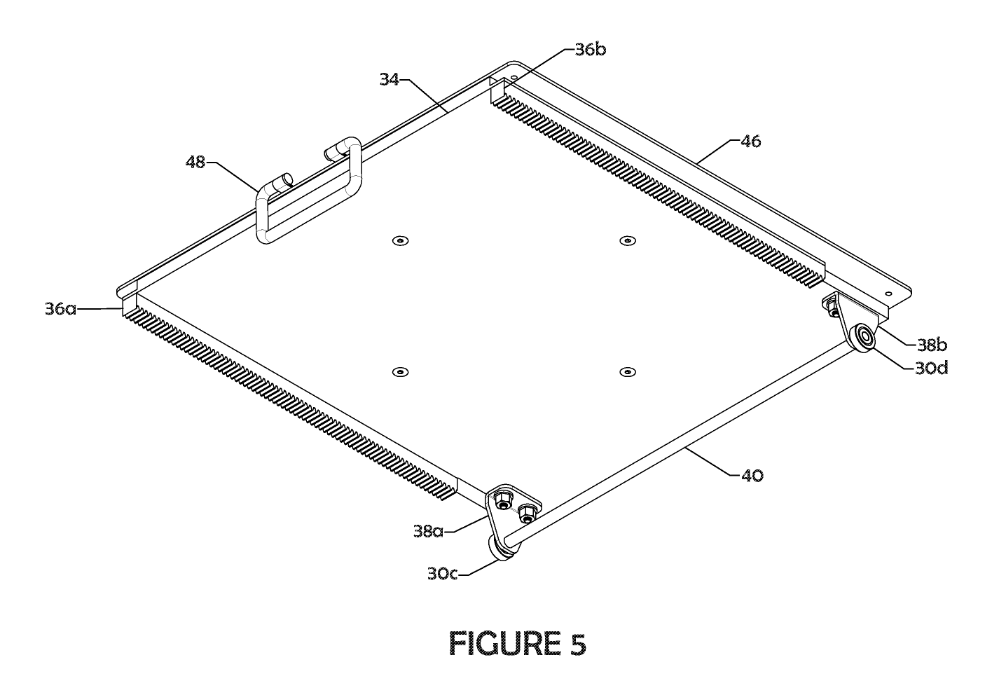

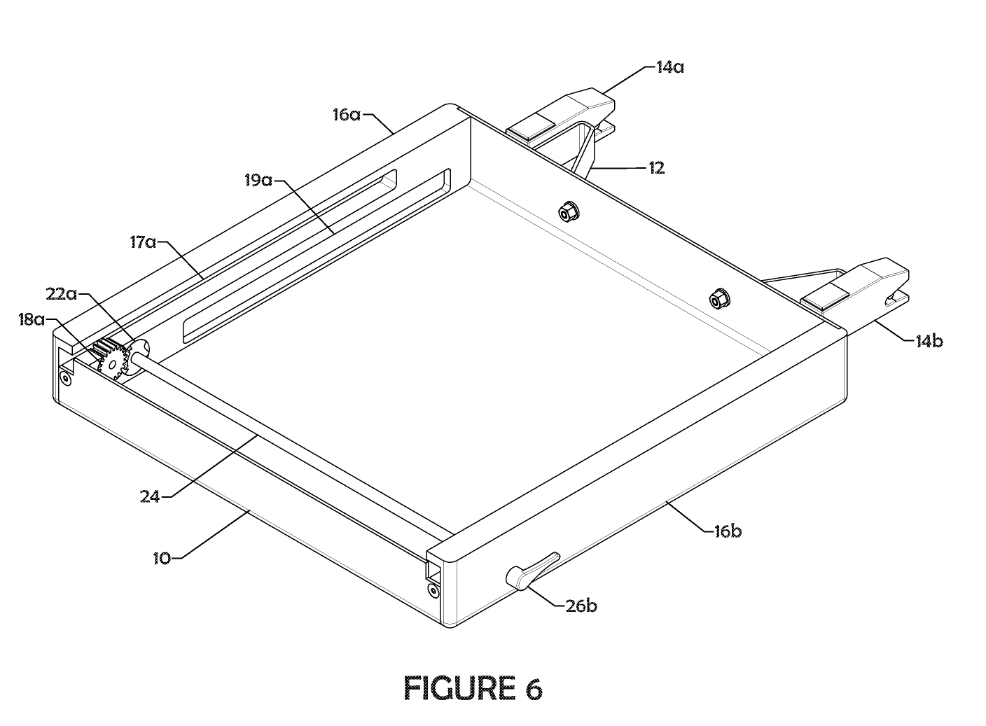

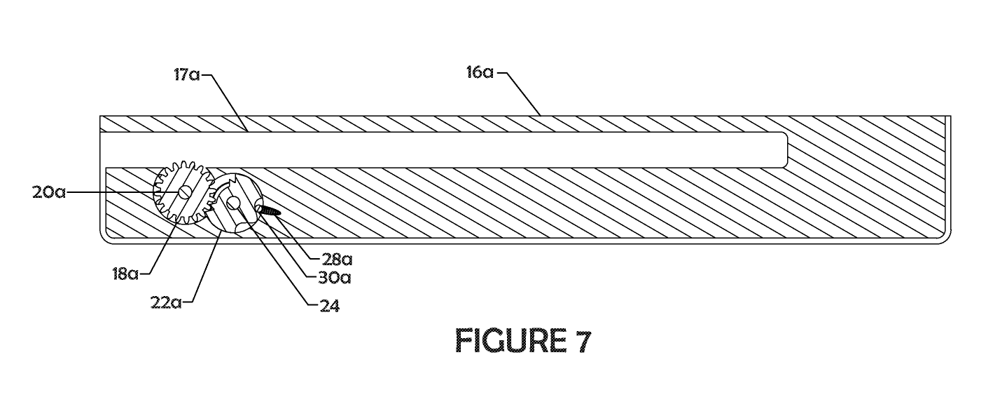

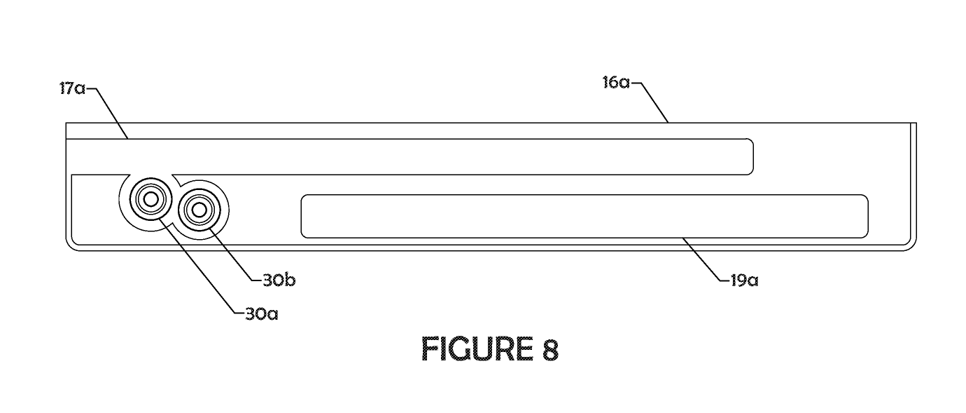

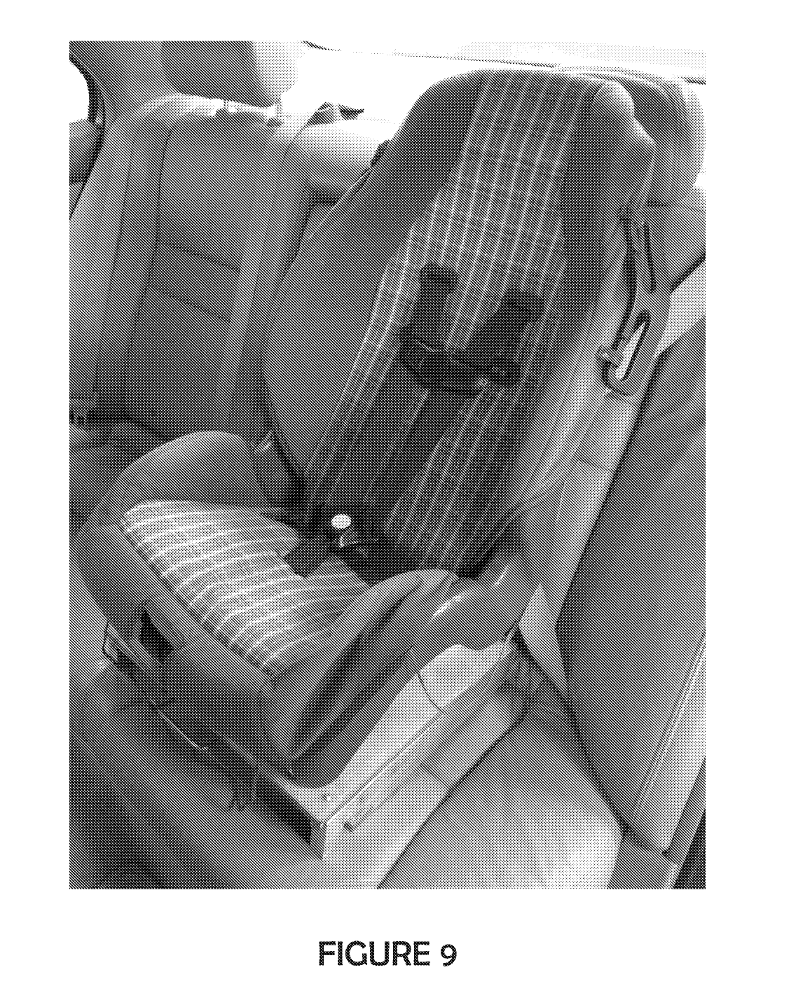

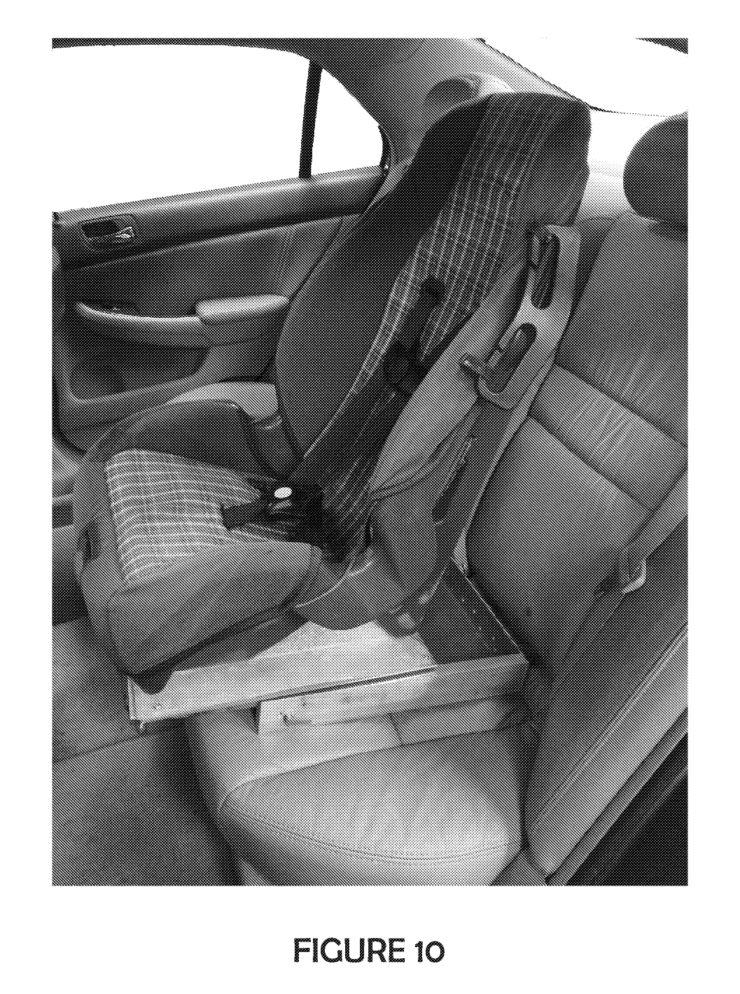

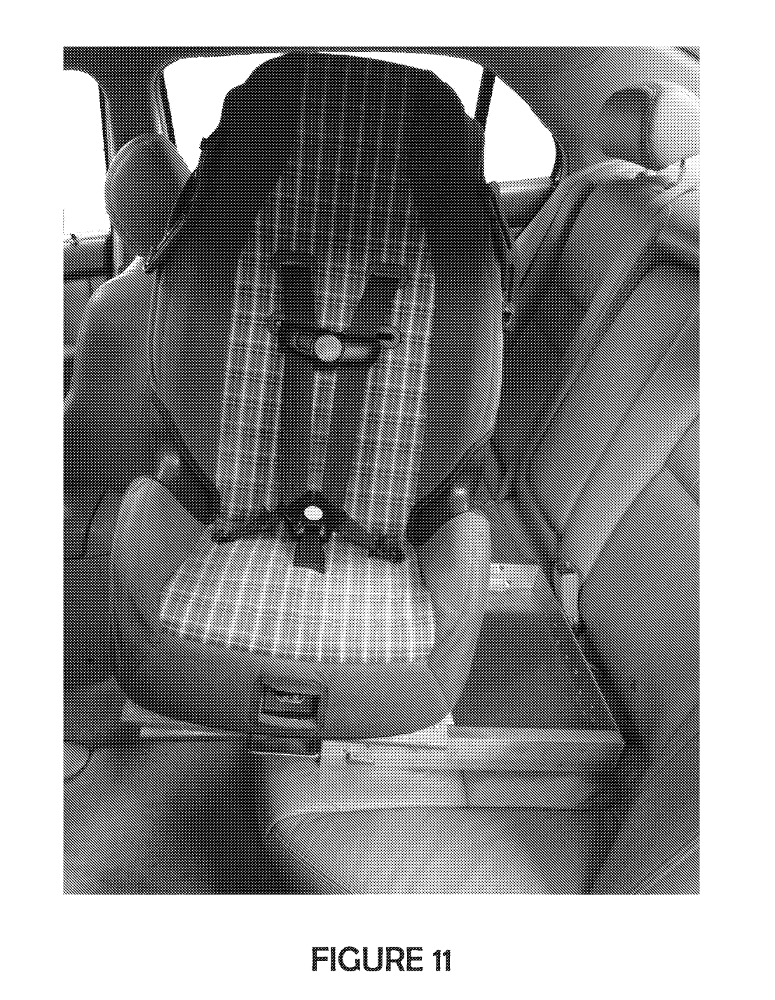

Referring now to FIG. 1, there is shown an isometric front view of the adapter assembly of the invention. Arms 16a, 16b are secured to the bottom plate 10. A LATCH connector support bracket 12 is attached to bottom plate 10. LATCH connectors 14a, 14b are affixed to the LATCH connector support bracket 12. Arms 16a, 16b house various components that aid in supporting the bearing base plate assembly which is shown in FIG. 5. The bearing base plate assembly partially consists of a bearing base plate 34, a turn table bearing 42 (not shown), and a top plate 46. The turn table bearing 42 is attached to the top of the bearing base plate 34. Attached to the top of the turn table bearing 42 is the top plate 46. Above the top plate 46 is secured the adapter plate 50. A handle 48 is pivotally attached to the upper portion of top plate 46. The handle 48 is a rigid fixture that allows caregivers to more effectively apply a torque to the top plate 46, ultimately rotating the child seat. Pawl toggles 26a, 26b are connected to the ends of the pawl connecting bar 24 (not shown). The pawl connecting bar 24 is inserted into bearings 32b, 32e (not shown), which are secured into apertures of the arms 14a, 14b (FIG. 6).

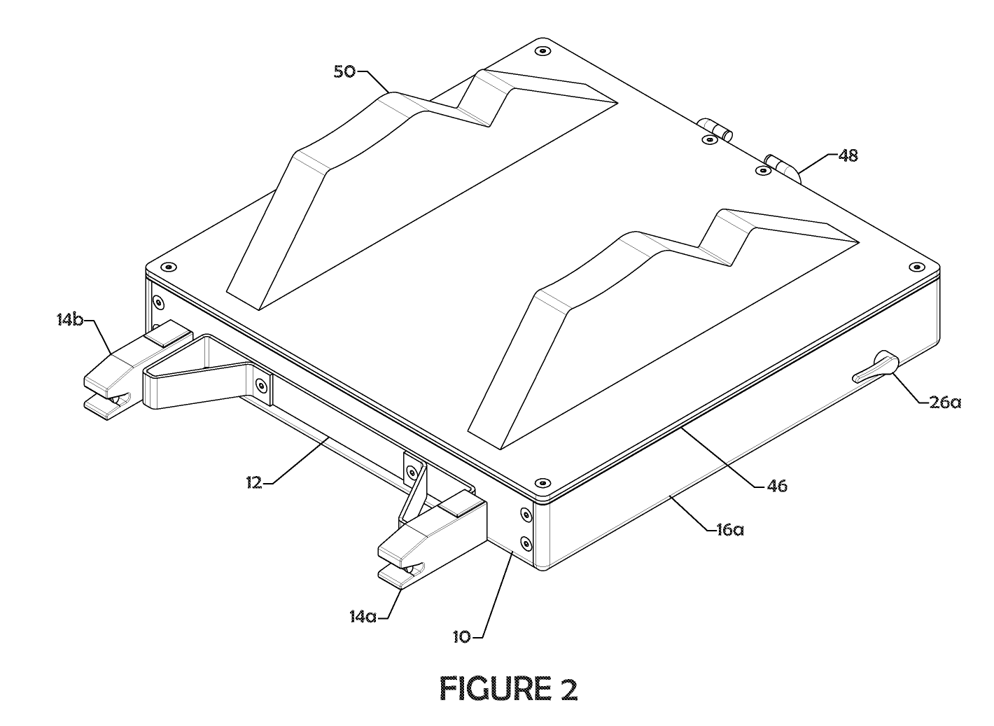

Referring now to FIG. 2, there is shown an isometric rear view of the adapter assembly of the invention. LATCH connectors 14a, 14b are secured to the LATCH connector support bracket 12. The LATCH connector support bracket 12 is secured to bottom plate 10.

Motor vehicles of model year 2003 or later have metal u-shaped anchors between the seat cushions in the rear of a vehicle (not shown). The LATCH connectors 14a, 14b secure the adapter assembly to the frame of a vehicle via the use of these u-shaped anchors. In the event that the adapter assembly experiences a sudden force, such as sudden braking or when an accident occurs, LATCH connectors 14a, 14b prevent the adapter assembly from moving in a direction collinear to the force. The LATCH connector support bracket 12 provides a rigid support fixture to connect the LATCH connectors 14a, 14b to the adapter assembly. The LATCH connector support bracket's 12 rigidity allows for easy installation and uninstallation of the adapter assembly to the motor vehicle.

The adapter plate 50 is fabricated to fit with a particular child seat. Adapter plate 50 can be coupled with the underside of the child seat, not shown. The coupling prevents the child seat from shifting or changing position when a small force is applied, such as would be experienced when a caregiver moves the child seat forward, backward, or rotates it.

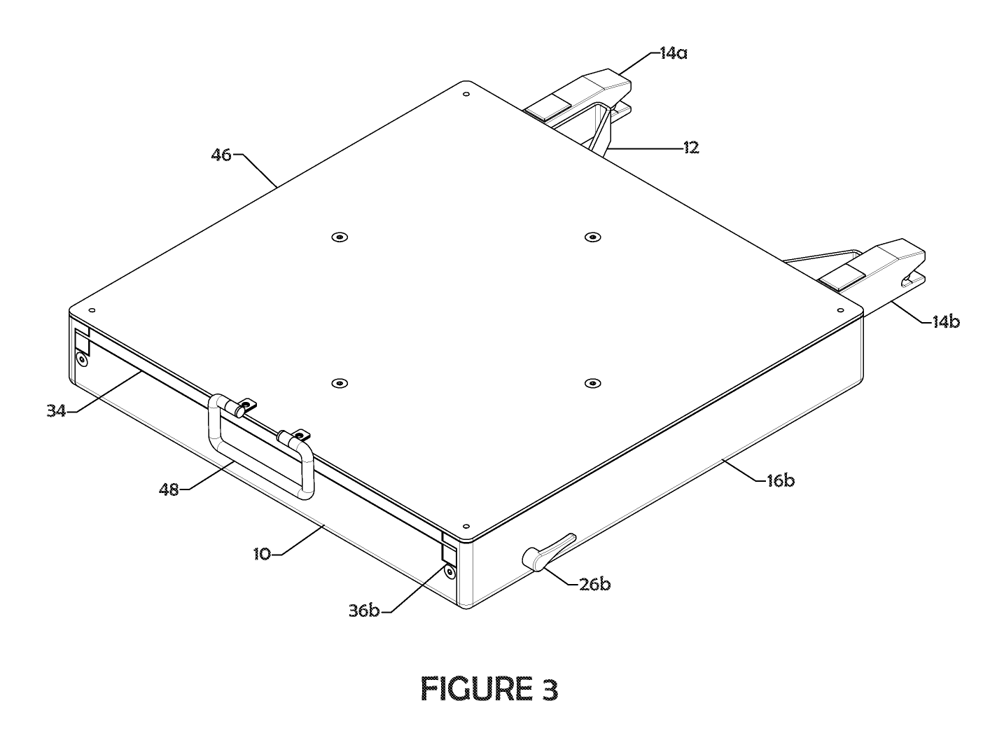

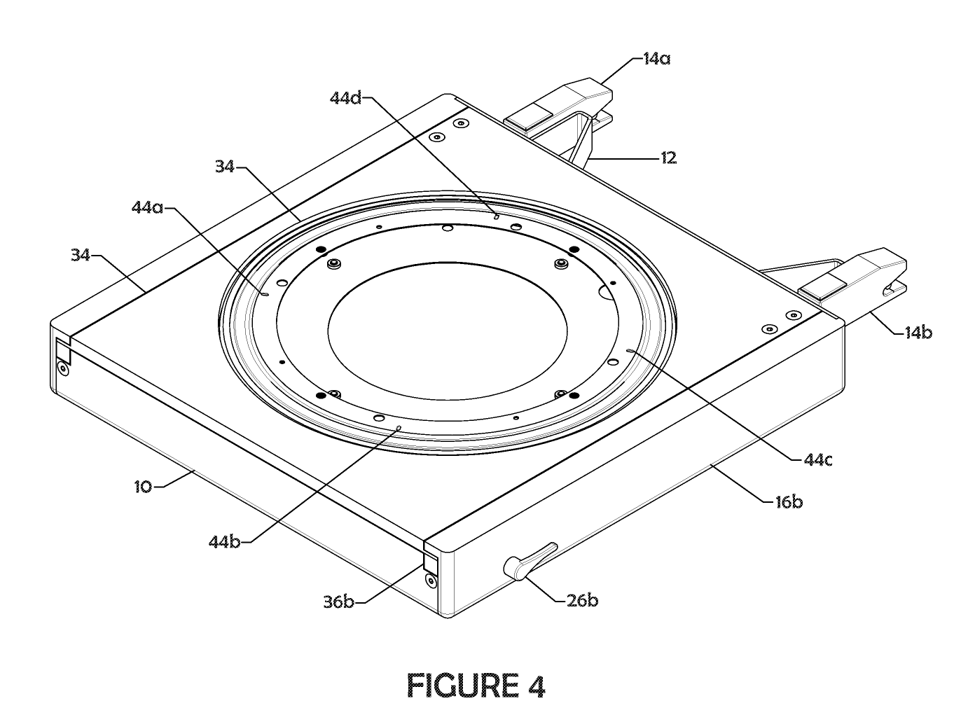

Referring now to FIG. 3, there is shown an isometric front view of the adapter assembly without the adapter plate 50. This exposes the top plate 46, which secures the adapter plate 50 to the adapter assembly. The top plate 46 is secured to the top of a turntable bearing 42 (FIG. 4), not shown in this FIG. 3.

Referring now to FIG. 4, there is shown an isometric front view of the adapter assembly without adapter plate 50 or top plate 46, exposing the turntable bearing 42 and bearing base plate 34. Turntable bearing 42 is secured to both the top plate 46 and bearing base plate 34. Turntable bearing 42 provides the rotational capabilities to the invention. In addition, turntable bearing 42 contains four detents 44a, 44b, 44c, and 44d placed at 90 degree increments to one another. The detents 44a, 44b, 44c, 44d create a ‘soft-locking’ mechanism, which allow the caregiver to easily position the child seat in both a forward facing and outboard facing position. For instance, when a caregiver wants to remove a child from a child seat, the caregiver will move the child seat in a forward direction and then rotate the child seat to an outboard position. The detents 44a, 44b, 44c, 44d allow the caregiver to easily move the child seat in a forward direction by resisting unintentional rotational forces, until at such time the caregiver wishes to rotate the child seat. Once the child seat is rotated, the detents 44a, 44b, 44c, 44d hold the child seat in the outboard position, allowing the caregiver to easily remove the child from the child seat. If a normal turntable bearing were used in place of one with detents, the incline of a vehicle's seat would cause unwanted rotation of the child seat. Similarly, when a caregiver is placing a child into the child seat, the detents 44a, 44b, 44c, 44d hold the child seat in an outboard position, preventing unwanted rotation. The caregiver can then rotate the child seat to a forward facing position, where the detents 44a, 44b, 44c, 44d will again hold the child seat, allowing the caregiver to move the child seat in rearward direction, ultimately bringing the rear of the child seat in contact with the backrest of the vehicle's seat.

Referring now to FIG. 5, there is shown an isometric view of the bearing base plate assembly in greater detail. Bearing base plate assembly consists of the top plate 46, handle 48, turntable bearing 42 (not shown), bearing base plate 34, racks 36a and 36b, support brackets 38a and 38b, a support bracket axle 40, and bearings 32c and 32d attached to the ends of support bracket axle 40. Bearings 32c and 32d aid in the linear motion of the invention. Top plate 46 is secured to turntable bearing 42, which is in turn secured to bearing base plate 34. Racks 36a, 36b and support brackets 38a, 38b are secured to the underside of bearing base plate 34. Support bracket axle 40 is placed between support brackets 38a, 38b. Furthermore, support brackets 38a, 38b properly position the support bracket axle 40 and bearings 32c, 32d such that the bearing base plate assembly remains level when the racks 36a, 36b mesh with the pinion gears 18a, 18b (FIG. 7), not shown in this FIG. 5.

Referring now to FIG. 6, there is shown an isometric view of the adapter assembly without the adapter plate 50 or bearing base plate assembly. This exposes the arms 16, 16b, pawl toggles 26a, 26b, pawl connecting bar 24, and bottom plate 10.

The bottom plate 10 secures both arms 16a and 16b. The arms 16a and 16b house various components. The racks 36a and 36b of the bearing base plate assembly are housed in the upper tracks 17a, 17b of the arms 16a, 16b. The bearings 32c and 32d from the bearing base plate assembly are housed in the lower tracks 19a, 19b of the arms 16, 16b. In addition, the arms 16a, 16b house the pinion gears 18a and 18b, the pinion gear shafts 20a and 20b, the pawls 22a and 22b, the ball bearings 30a and 30b, the springs 28a and 28b, and the bearings 32a, 32b, 32e, and 32f.

The pawl toggles 26a and 26b are secured to the ends of the pawl connecting bar 24. The pawls 22a, 22b are also secured to the pawl connecting bar 24. When either of the pawl toggles 26a or 26b are rotated, the pawl connecting bar 24 and pawls 22a, 22b are also rotated, transmitting the rotational motion from one side of the adapter assembly to the other.

Referring now to FIG. 7, there is shown a cross sectional view of the arm. The pinion gear 18a is secured to the pinion gear shaft 20a, which is in turn secured to the bearing 32a. The racks 36a, 36b from the bearing base plate assembly mesh with pinion gears 18a and 18b. Together the racks 36a, 36b and the pinion gears 18a, 18b, pinion gear shafts 20a, 20b, and bearings 32a, 32f aid in the linear motion of the adapter assembly. When the racks 36a, 36b are moved either forward or backward, the pinion gears 18a, 18b will rotate. Depending upon the pawl toggles 26a, 26b orientation the pawls 22a, 22b will either engage with or will not engage with the pinion gears 18a, 18b. If the pawl toggles 26a, 26b are positioned such that the pawls 22a, 22b mesh with the pinion gears 18a 18b, the ball bearings 30a, 30b and springs 28a, 28b will exert a torque on the pawls 22a, 22b, keeping the pawls 22a, 22b engaged with the pinion gears 18a, 18b. If the racks 36a, 36b are moved in a direction that causes the pinion gears 18a, 18b and pawls 22a, 22b to rotate towards one another, the pawls 22a, 22b will obstruct the rotation of the pinion gears 18a, 18b. This in turn will not allow the racks 36a, 36b to move in the currently desired direction. However, if the racks 36a, 36b are moved in a direction that causes the pinion gears 18a, 18b and pawls 22a, 22b to rotate away from one another, the pinion gears 18a, 18b will exert a torque on the pawls 22a, 22b causing the pawls 22a, 22b to rotate. The rotation of the pawls 22a, 22b will also cause the ball bearings 30a, 30b to compress the springs 28a, 28b.

The length of the lower tracks 19a, 19b limits the distance the child seat can be moved forward or backward. As the child seat is moved forward or backward, the bearings 32c, 32d from the bearing base plate assembly are obstructed by the ends of the lower tracks 19a, 19b.

Referring now to FIG. 8, there is shown a right angled projection of the arm. Two bearings 30a, 30b are secured to the arm 16a. The pinion gear shaft 20a is secured to one of the bearings 30a, while the pawl connecting bar 24 is secured to the other bearing 30b. The bearing 30b that is secured to the pawl connection bar 24 aids in the rotational motion of the pawl connecting bar 24 and pawl 22a. The pinion gear 18a is secured to the opposite end of the pinion gear shaft 20a.

Referring now to FIG. 9, there is shown a photographic view of the adapter assembly secured to a vehicle via the use of the LATCH connectors 14a, 14b. The child seat is secured to the adapter assembly by its coupling with the adapter plate 50. The seat belt of the vehicle is routed through the rear of the child seat and secured to its respective buckle. If the vehicle's seat belt is loose, excess material is fed back into the vehicle's tensioners, firmly securing the child seat to the vehicle.

Referring now to FIG. 10, there is shown a photographic view of the adapter assembly moving the child seat forward. This action creates enough space for the child seat to rotate, clearing the backrest of the vehicle's seat.

Referring now to FIG. 11, there is shown a photographic view of the adapter assembly rotating the child seat. This action allows the child seat to face an outboard position, in turn allowing the caregiver to more easily place the child into and out of the vehicle. The caregiver will also experience less strain as a result.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

What is claimed is:

1. An adapter assembly for moving a motor vehicle child seat longitudinally and rotationally relative to a motor vehicle seat, the assembly comprising:
a) a planar bearing base plate having racks connected thereto and operatively connected to pinion gears, in turn operatively connected to a bi-directional locking mechanism;
b) a rotatable turntable disposed on and operatively connected to said bearing base plate;
c) a planar top plate disposed on and operatively connected to said rotatable turntable; and
d) an adapter plate disposed on and operatively connected to said top plate, said adapter plate fabricated to couple to a child seat having predetermined dimensions.

2. The adapter assembly in accordance with claim 1, further comprising a handle secured to said top plate.

3. The adapter assembly in accordance with claim 1, further comprising a bottom plate and arms for supporting said bearing base plate.

4. The adapter assembly in accordance with claim 3, wherein said locking mechanism comprises two latch connectors connected to said bottom plate.

5. The adapter assembly in accordance with claim 4, further comprising a latch connector support bracket respectively connected to said two latch connectors and to said bottom plate.

6. The adapter assembly in accordance with claim 1, further comprising a pawl connecting bar and a pawl toggle operatively connected to said pawl connecting bar.

7. The adapter assembly in accordance with claim 6, further comprising arms perpendicularly attached to said bottom plate and to said bearing base plate, at least one of said arms having an aperture through which said pawl connecting bar is inserted.

8. The adapter assembly in accordance with claim 1, wherein said rotatable turntable comprises a turntable bearing.

9. The adapter assembly in accordance with claim 8, wherein said turntable bearing comprises a plurality of detents.
